(19) United States
(12) Patent Application Publication
(10) Pub. No.: US 2014/0220336 A1
(43) Pub. Date: Aug. 7, 2014

(54) PRESSURE-SENSITIVE ADHESIVES THAT MINIMIZE PLASTICIZER MIGRATION, PRESSURE-SENSITIVE ADHESIVE ARTICLES WITH SUCH PRESSURE-SENSITIVE ADHESIVES, AND METHODS FOR FABRICATING SUCH PRESSURE-SENSITIVE ADHESIVES

(71) Applicant: HONEYWELL INTERNATIONAL INC., Morristown, NJ (US)

(72) Inventors: Yu Chen, Shanghai (CN); Xinyu Li, Shanghai (CN)

(73) Assignee: HONEYWELL INTERNATIONAL INC., Morristown, NJ (US)

(21) Appl. No.: 13/834,393

(22) Filed: Mar. 15, 2013

Related U.S. Application Data
(60) Provisional application No. 61/760,675, filed on Feb. 5, 2013.

(51) Int. Cl. C09J 7/02; C09J 9/00

(52) U.S. Cl. CPC C09J 7/0214; C09J 9/00
USPC 428/339; 524/275; 428/356

(57) ABSTRACT

Pressure-sensitive adhesives that minimize and/or resist plasticizer migration, pressure-sensitive adhesive articles with such pressure-sensitive adhesives, and methods for fabricating such pressure-sensitive adhesives are provided. In an embodiment, a pressure-sensitive adhesive includes a wax chosen from ethylene-acrylic acid copolymer, ethylene-vinyl acetate, or mixtures thereof. The pressure-sensitive adhesive also contains a natural rubber, a synthetic rubber, a tackifier, and a solvent.

### PRIORITY CLAIMS

This application claims the benefit of U.S. Provisional Application No. 61/760,675, filed Feb. 5, 2013.

### TECHNICAL FIELD

The technical field generally relates to pressure-sensitive adhesives, pressure-sensitive adhesive articles with such pressure-sensitive adhesives, and methods for fabricating such pressure-sensitive adhesives, and more particularly relates to pressure-sensitive adhesives that resist or minimize plasticizer migration, polyvinyl chloride substrates with such pressure-sensitive adhesives, and methods for fabricating such pressure-sensitive adhesives.

### BACKGROUND

A pressure-sensitive adhesive (PSA) is an adhesive that bonds with an adherent when pressure is applied to it. PSAs contrast, for example, with adhesives that are activated by heat, irradiation, or a chemical reaction. PSAs can be applied to a substrate as an emulsion or dispersion, which is then dried to remove a liquid carrier. Alternatively, PSAs can be applied as a solid that is then heated to reduce its viscosity.

PSA compositions are often applied on polyvinyl chloride (PVC) substrates, such as, for example, PVC tape. PVC substrates typically contain plasticizers such as dioctyl phthalate (DOP) or certain polymers. These plasticizers have a tendency to migrate to the adhesive applied to the PVC substrate after storage or aging at elevated temperatures. This migration of the plasticizers compromises the adhesive property of the PSA.

Accordingly, it is desirable to provide a PSA that resists and/or minimizes the migration of plasticizers from PVC substrates. In addition, it is desirable to provide PSA articles with such pressure-sensitive adhesives. It also is desirable to provide methods for fabricating such PSAs. Furthermore, other desirable features and characteristics of the various embodiments will become apparent from the subsequent detailed description and the appended claims, taken in conjunction with the accompanying drawings and this background.

### BRIEF SUMMARY

Pressure-sensitive adhesives that minimize and/or resist plasticizer migration, pressure-sensitive adhesive articles with such pressure-sensitive adhesives, and methods for fabricating such pressure-sensitive adhesives are provided. In accordance with an exemplary embodiment, a pressure-sensitive adhesive includes a wax chosen from ethylene-acrylic acid copolymer, ethylene-vinyl acetate, or mixtures thereof. The pressure-sensitive adhesive also contains a natural rubber, a synthetic rubber, a tackifier, and a solvent.

In accordance with another embodiment, a pressure-sensitive adhesive article includes a PVC substrate and a pressure-sensitive adhesive overlying the PVC substrate. The pressure-sensitive adhesive contains a wax chosen from ethylene-acrylic acid copolymer, ethylene-vinyl acetate, or mixtures thereof. The pressure-sensitive adhesive also contains natural rubber, synthetic rubber, and a tackifier.

In accordance with a further embodiment, a method for fabricating a pressure-sensitive adhesive is provided. The method includes mixing a wax chosen from ethylene-acrylic acid copolymer, ethylene-vinyl acetate, and mixtures thereof with natural rubber until particles of the wax are uniformly distributed throughout the natural rubber to form a wax/rubber combination. The wax/rubber combination, synthetic rubber, and a tackifier are dissolved in a solvent.

### BRIEF DESCRIPTION OF THE DRAWINGS

The various embodiments will hereinafter be described in conjunction with the following drawing figures, wherein like numerals denote like elements, and wherein:

FIG. 1 is a cross-sectional view of a pressure-sensitive adhesive article in accordance with an exemplary embodiment;

FIG. 2 is a flowchart of a method for fabricating a pressure-sensitive adhesive in accordance with an exemplary embodiment;

FIGS. 3 and 4 are bar charts illustrating the results of a peel test comparing the peel force of pressure-sensitive adhesives containing four different waxes according to various exemplary embodiments when peeled from a PVC sheet containing a DOP plasticizer and a polymeric plasticizer, respectively; and

FIG. 5 is a bar chart illustrating the results of a peel test comparing the peel force of pressure-sensitive adhesives containing two different amounts of the same wax in accordance with exemplary embodiments and no wax.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

The various embodiments contemplated herein are directed to pressure-sensitive adhesives that resist and/or minimize migration of plasticizers from PVC substrates. The pressure-sensitive adhesives are solvent-based and contain a wax that suppresses the migration of plasticizers, such as dioctyl phthalate (DOP) or other polymer plasticizers, that migrate from the PVC substrates and compromise the adhesive properties of the pressure-sensitive adhesives. The wax is chosen from ethylene-acrylic acid copolymers, ethylene-vinyl acetate copolymers, and mixtures thereof

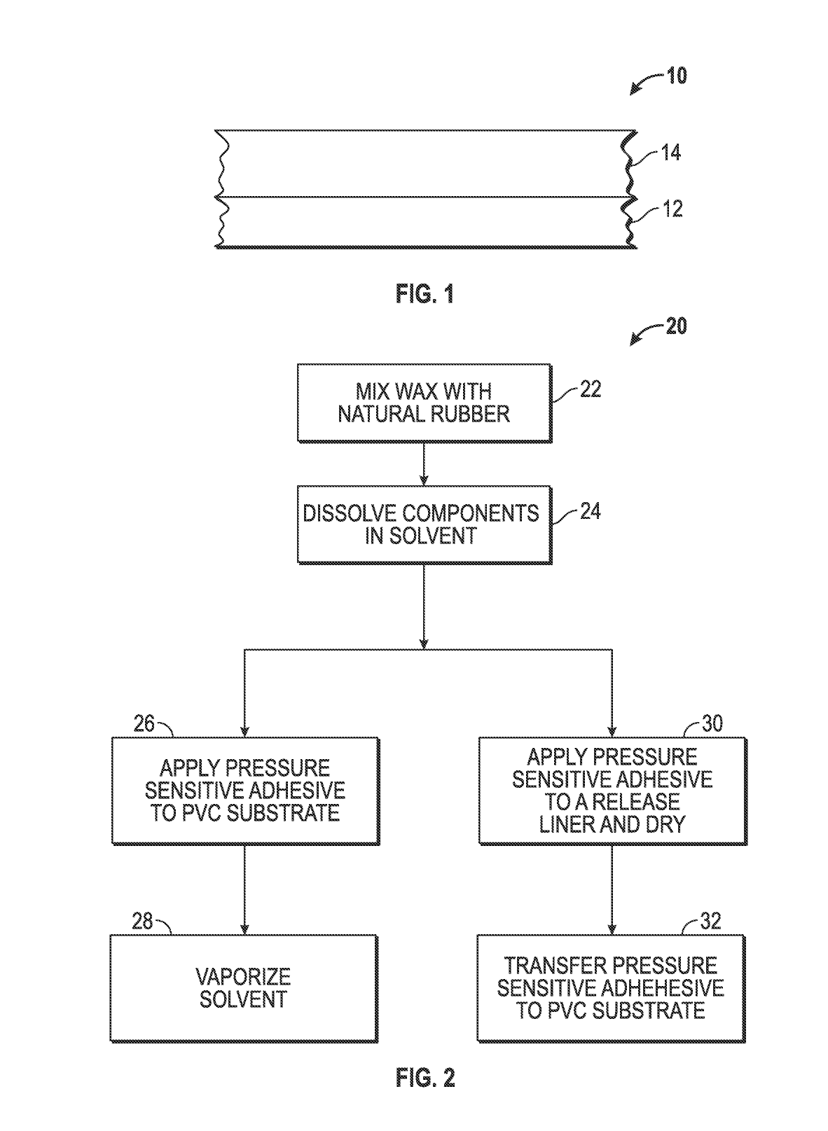

FIG. 1 is a cross-sectional view of a pressure-sensitive adhesive article 10, such as a pressure-sensitive adhesive tape, in accordance with an exemplary embodiment. The pressure-sensitive adhesive article 10 has a pressure-sensitive adhesive 14 overlying a PVC substrate 12. As used herein, the term “overlying” encompasses the terms “on” and “over”. Accordingly, the pressure-sensitive adhesive can be applied directly onto the PVC substrate or may be deposited over the substrate such that one or more other materials are interposed between the adhesive and the substrate, although migration of a plasticizer to the adhesive may still be of an issue. The PVC substrate may be formed of copolymers of vinyl chloride and various co-monomers in addition to homopolymers of vinyl chloride, as long as vinyl chloride monomers amount to 50 mass % or more. The PVC substrate also may comprise plasticisers such as polymer plasticizers, DOP, and the like. The PVC substrate may have a thickness suitable for its application. While the pressure-sensitive adhesive 14 is illustrated in FIG. 1 on one surface of PVC substrate 12, it will be appreciated that the pressure-sensitive adhesive can be deposited on more than one surface of the PVC substrate. The side(s) of the PVC substrate 12 to which the pressure-sensitive adhesive 14 is applied may undergo surface treatments such as, for example, primer coatings or corona discharge followed by primer coating treatment to facilitate adhesion of the pressure-sensitive adhesive 14 to the PVC substrate.

As noted above, the pressure sensitive adhesive 14 contains a wax that is an ethylene-acrylic acid copolymer, an ethylene-vinyl acetate copolymer, and/or a mixture thereof. Ethylene-acrylic acid copolymers used in the pressure sensitive adhesives contemplated herein are produced by the polymerization of ethylene and acrylic acid monomers, usually using a free radical initiator. The acrylic acid content of the copolymer contributes to the copolymer's polarity and adhesion and lowers its crystallinity. As the content of the acrylic acid monomer in the polymer increases, the crystallinity of the ethylene-acrylic acid copolymer decreases. The amount of acrylic acid monomer in the copolymer, or the copolymer's acid number is determined by method ASTM D-1386. Polymers with a high acid number contain a high content of acrylic acid monomers. Commercial grades of ethylene-acrylic acid copolymers suitable for use herein are available in acid numbers from about 10 to about 200 mg KOH/g. The number average molecular weight (Mn) of the ethylene-acrylic acid copolymers ranges from about 1,000 to about 6,000 and their weight average molecular weight (Mw) ranges from about 2,000 to about 10,000. The molecular weight of ethylene-acrylic acid copolymers is determined by Gel Permeation Chromatography (GPC). The density of the polymers ranges from about 0.90 to about 1.00 g/cc as determined by method ASTM D-1505. The Mettler Drop Point of the polymers ranges from about 70 to about 110° C. as determined by method ASTM D-3954. The viscosity of ethylene-acrylic acid copolymers at 140° C. ranges from about 200 to about 1,000 cps as determined by a Brookfield rotational viscometer. The hardness of the ethylene-acrylic acid copolymers at 25° C. ranges from about 1 to about 50 dmm as determined by method ASTM D-5. An example of a commercially available ethylene-acrylic acid copolymer suitable for use in the pressure-sensitive adhesive contemplated herein is A-C® 540 and A-C® 5120 from Honeywell International Inc. of Morristown, N.J. A-C® 540 has an acid number of about 37-44 mg KOH/g, a hardness at 25° C. of less than 2.5 dmm, a viscosity at 140° C. (Brookfield) of 575 cps, a drop point (Mettler) of 105° C., and a density of 0.93 g/cc. A-C® 5120 has an acid number of 112 to 130 mg KOH/g, a hardness at 25° C. of less than 15 dmm, a viscosity at 140° C. (Brookfield) of 600 cps, a drop point (Mettler) of 92° C., and a density of 0.93 g/cc. Other commercially available ethylene-acrylic acid copolymers suitable for use in the pressure-sensitive adhesive contemplated herein include A-C® 580, and A-C® 5180, both available from Honeywell International Inc. A-C® 580 has an acid number of 75 mg KOH/g, a hardness at 25° C. of less than 4.0 dmm, a viscosity at 140° C. (Brookfield) of 650 cps, a drop point (Mettler) of 95° C., and a density of 0.93-0.94 g/cc. A-C® 5180 has an acid number of 200 mg KOH/g, a hardness at 25° C. of less than 50 dmm, a viscosity at 140° C. (Brookfield) of 625 cps, a drop point (Mettler) of 76° C., and a density of 0.93-0.94 g/cc.

Ethylene-vinyl acetate copolymers used in the pressure sensitive adhesive contemplated herein are produced by the polymerization of ethylene and vinyl acetate monomers, usually using a free radical initiator. Polymers with high acid number contain a high content of vinyl acetate monomers. Commercial grades of ethylene-vinyl acetate copolymers suitable for use herein are available in vinyl acetate % (VA %) from about 5 to about 30%. The Mn of the ethylene-vinyl acetate copolymers ranges from about 2,000 to about 8,000 and their Mw ranges from 3,000 to 15,000. The density of the polymers ranges from about 0.90 to about 1.00 g/cc as determined by method ASTM D-1505. The Mettler Drop Point of the polymers ranges from about 70 to about 110° C. as determined by method ASTM D-3954. The viscosity of the ethylene-vinyl acetate copolymers at 140° C. ranges from about 200 to about 1,000 cps as determined by the Brookfield rotational viscometer. The hardness of the ethylene-vinyl acetate copolymers at 25° C. ranges from about 1 to about 50 dmm as determined by method ASTM D-5. An example of a commercially available ethylene-vinyl acetate copolymer suitable for use in the pressure-sensitive adhesive contemplated herein is A-C® 405 from Honeywell International. A-C® 405 has VA % of about 6 to about 10.5%, a hardness at 25° C. of less than 7 dmm, a viscosity at 140° C. (Brookfield) of 600 cps, a drop point (Mettler) of about 94 to about 102, and a density of 0.92 g/cc. In an exemplary embodiment, the wax is present in the pressure-sensitive adhesive in an amount of about 1 weight percent (wt. %) to about 20 wt. %, for example, in an amount of about 4 wt. % to about 12 wt. %, such as, in an amount of about 4.5 wt. % to about 10 wt. %, of the total weight of the pressure-sensitive adhesive.

In an embodiment, the pressure-sensitive adhesive contains a natural rubber. The natural rubber is not particularly limited and can be unmodified, modified, or a combination thereof. The natural rubber can be modified with, for example, an acrylic acid ester, and the like. The natural rubber is present in amount of about 15 wt. % to about 45 wt. % of the total weight of the pressure-sensitive adhesive in an embodiment.

The pressure-sensitive adhesive also contains a synthetic rubber in an exemplary embodiment. As with the natural rubber, the synthetic rubber is not particularly limited and can be unmodified, modified, for example by carboxylates, or a combination thereof. In an embodiment, the synthetic rubber is present in an amount of about 10 wt. % to about 40 wt. % of the total weight of the pressure-sensitive adhesive.

In a further embodiment, the pressure-sensitive adhesive also has a tackifier. Tackifiers suitable for use in the pressure-sensitive adhesive contemplated herein are low molecular weight resins with molecular weight (Mn) in the range of from about 500 to about 1500. The tackifier is present in an amount of about 40 to about 70 wt. % of the total weight of the pressure-sensitive adhesive in an exemplary embodiment.

Suitable tackifiers include terpene-based tackifying resins, petroleum-based resins, and the like. The various tackifying resins can be used alone or in combination with each other. Examples of terpene-based resins suitable for use herein include α-pinene resins, β-pinene resins, aromatic terpene resins, terpene phenol resins, and the like. Examples of petroleum-based resins suitable for use herein include aliphatic, aromatic, co-polymeric, and alicyclic petroleum-based resins, hydrogenated products thereof, and the like. Aromatic petroleum resins include polymers using only one kind or two or more kinds of vinyl group-containing aromatic hydrocarbons having from 8 to 10 carbon atoms, for example, styrene, indene, and methylindene. The aromatic petroleum resins obtained from a fraction such as vinyltoluene and indene (so-called “C9 petroleum fraction” or “C9-based petroleum resins”) are particularly suitable.

Aliphatic petroleum resins include polymers using only one, two, or more olefins or dienes having from 4 to 5 carbon atoms, for example, olefins such as butane-1, isobutylene, and pentene-1, and dienes such as butadiene, piperylene (1,3-pentadiene), and isoprene. The aliphatic petroleum resins obtained from a fraction such as butadiene, piperylene, and isoprene (so-called “C4 petroleum fraction” or “C5 petroleum fraction”, that is, so-called “C4-based petroleum resins” or “C5-based petroleum resins,” respectively, and the like) are particularly suitable. Examples of the aliphatic/aromatic petroleum resin include styrene-olefin-based copolymers. As an aliphatic/aromatic petroleum resin, so-called “C5/C9 copolymer-based petroleum resins” and the like can be particularly suitable.

As noted above, the pressure-sensitive adhesive is solvent-based, that is, the pressure-sensitive adhesive contains a solvent that is capable of dissolving the wax, the natural rubber, the synthetic rubber, and the tackifier. An example of a suitable solvent includes, but is not limited to, toluene. In an exemplary embodiment, the toluene is present in the pressure-sensitive adhesive such that the pressure-sensitive adhesive has about a 20 to 40%, for example, a 30%, solid content.

The pressure-sensitive adhesive also may contain various additives generally used in the field of solvent dispersion-type pressure sensitive adhesives. Such additives include, but are not limited to, anti-aging agents, antioxidants, pigments, and the like. In an embodiment, an antioxidant is present in an amount of about 0.5 to about 3 wt. % of the total weight of the pressure-sensitive adhesive.

In accordance with an exemplary embodiment, a method 20 for fabricating a pressure-sensitive adhesive is illustrated in FIG. 2. The method 20 includes mixing a wax with natural rubber (block 22). As describe above, the wax can be chosen from ethylene-acrylic acid copolymer, ethylene-vinyl acetate copolymer, and/or mixtures thereof Ethylene-acrylic acid copolymer and ethylene-vinyl acetate copolymer are not dissolvable in solvents such as toluene; accordingly, the wax(es) is mixed with the natural rubber until it is uniformly distributed throughout the natural rubber. In one embodiment, the wax is mixed in the natural rubber by milling, for example, using a 2-roll mill, multiple times until the wax is uniformly distributed throughout one or more natural rubber sheets.

Next, the wax/natural rubber combination (e.g., a sheet), the synthetic rubber, the tackifier, and any other optional additives are dissolved in a solvent such as, for example, toluene (block 24). In one embodiment, the wax/natural rubber combination (or sheet) is dissected into small pieces before being added into the solvent to facilitate dispersion of the material. A sufficient amount of solvent is provided such that a pressure-sensitive adhesive with about from 25 to about 40%, for example, 30%, solid content is obtained.

A pressure-sensitive adhesive article 10, such as the pressure-sensitive adhesive article 10 of FIG. 1, can be produced with the continuation of method 20. In one embodiment, the pressure-sensitive adhesive formed in block 24 is directly applied to a first side of a PVC substrate (block 26). The pressure-sensitive adhesive can be applied by gravure roll coater, reverse roll coater, spray coater, paint brush, and the like. The pressure-sensitive adhesive article is then subjected to heat to evaporate the solvent or is air dried to allow the solvent to evaporate (block 28). In another embodiment, the pressure-sensitive adhesive is applied to and dried on the surface of a release liner to form a pressure-sensitive adhesive layer thereon (block 30). The pressure-sensitive adhesive is subjected to heat to evaporate the solvent or is air dried to allow the solvent to vaporize. The resulting pressure-sensitive adhesive layer then is transferred to a PVC substrate (block 32). In this embodiment, the release liner can be laminated to the PVC substrate with the pressure-sensitive adhesive therebetween. Next, the laminated construction can be submitted to a two-roller assembly with pressure. The release liner is then peeled from the laminated construction leaving the pressure-sensitive adhesive on the PVC substrate. In both embodiments, once dried, the pressure-sensitive adhesive may have a thickness in the range of from about 2 to about 150 microns (μm), for example, from about 5 to about 100 μm, such as, from about 10 to about 80 μm.

The following are examples of pressure-sensitive adhesives and methods for making those pressure-sensitive adhesives. The examples are provided for illustration purposes only and are not meant to limit the various embodiments in any way.

For the following examples, a 3# smoked natural rubber from Thailand was used and the synthetic rubber was a styrene-butadiene rubber available under the trademark SBR 1502 from SINOPEC China Petrochemical Corporation. Escorez® 1401 modified C5 hydrocarbon resin from ExxonMobile of Irving, Tex. was used as the tackifier. An Irganox® 1010 antioxidant from BASF of Germany was also added. The following waxes from Honeywell International were used: A-C® 5120, A-C® 540, A-C® 580, A-C® 5180, and A-C® 405M.

Each pressure-sensitive adhesive was prepared by mixing the wax and the natural rubber as described above with reference to the method 20 of FIG. 2 in the concentrations, in grams, set forth in Table 1 below. The wax and the natural rubber were mixed using a 2-roll mill forming the mixture of the wax and natural rubber into the form of a sheet. The sheet was introduced to the 2-roll mill repeatedly until the wax was uniformly distributed throughout the natural rubber. The sheet was then sliced into small pieces and dissolved in toluene. The synthetic rubber, the antioxidant, and the tackifier were also dissolved in the toluene. Toluene was present in an amount to produce a pressure sensitive adhesive with a 30% solid content.

| | Example 1 | Example 2 | Example 3 | Example 4 | Example 5 | Comparative |
|---|---|---|---|---|---|---|
| | A-C ® 405M | A-C ® 5120 | A-C ® 580 | A-C ® 540 | A-C ® 540 | Example |
| Natural rubber | 21.80 | 21.80 | 21.80 | 21.80 | 21.23 | 22.88 |
| Synthetic rubber | 14.51 | 14.51 | 14.51 | 14.51 | 14.14 | 15.25 |
| Tackifier | 45.35 | 45.35 | 45.35 | 45.35 | 44.30 | 47.65 |
| Wax | 4.10 | 4.10 | 4.10 | 4.10 | 6.02 | 0 |
| Irganox_1010 | 0.3 | 0.3 | 0.3 | 0.3 | 0.3 | 0.3 |
| Toluene | 200 | 200 | 200 | 200 | 200 | 200 |

In Example 5, the amount of A-C® 540 was increased from about 4.8 wt. % used in Examples 1-4 to about 7 wt. % of the total weight of the pressure-sensitive adhesive.

In another example, PVC tape also was prepared. Each of the five pressure-sensitive adhesives above was directly coated on one sheet of PVC film. This first sheet (PVC-1) was of PVC having a polymeric plasticizer. The pressure-sensitive adhesives were then covered with another sheet of PVC film so that the pressure-sensitive adhesives were between the two PVC sheets. This second sheet (PVC-2) was of PVC having a DOP plasticizer. Next, a portion of the PVC-1 sheet was aged at 90° C. for 16 hours, while a portion of the PVC-2 sheet was aged at 60° C. for 24 hours.

A Peel Test on a stainless steel surface using ASTMD1876-08 was conducted to assess the performance of the five pressure-sensitive adhesives. The test was conducted by applying a strip of tape to a standard stainless steel panel with controlled pressure. The tape was peeled from the surface at a peel speed of 300 mm/minute at a 180° angle, during which time the force required to effect the tape's removal was measured. The strip of tape was a 20 mm wide strip. The test panel was at least 120 mm long and 50 mm wide and not less than 1.1 mm thick.

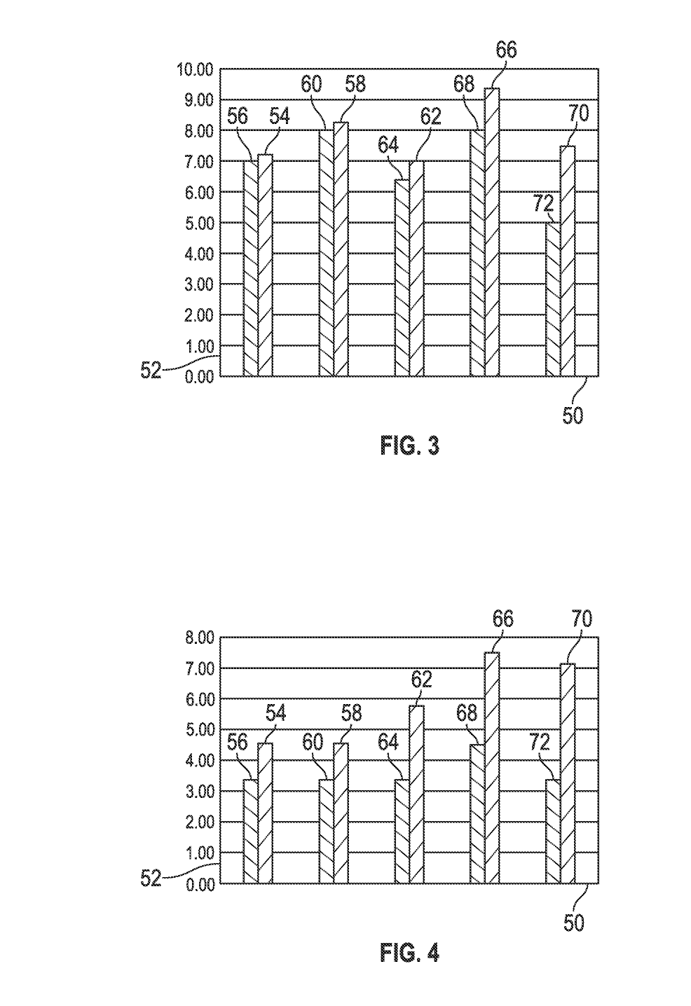

FIG. 3 is a bar chart illustrating the Peel Test results of aged and initial PVC-2 sheets, where the x-axis 50 represents the pressure-sensitive adhesives of Table 1 with A-C® 405M in the initial state 54 and A-C® 405M in the aged state 56, A-C® 5120 in the initial stage 58 and A-C® 5120 in the aged state 60, A-C® 580 in the initial state 62, and A-C® 580 in the aged state 64, A-C® 540 (4.8 wt. %) in the initial state 66, and A-C® 540 (4.8 wt. %) in the aged state 68, and the Comparative Example (no wax) in the initial state 70 and the Comparative Example (no wax) in the aged state 72. The y-axis 52 represents the force required to remove the tape in Newtons/20 mm. As can be seen from FIG. 3, compared to the Comparative Example, the force necessary to peel the tape from the test panel increased with the presence of the four waxes. This is notable as the end user typically works with pressure-sensitive adhesive articles, such as tape, in the aged state.

FIG. 4 is a bar chart illustrating the Peel Test results of PVC-1 sheets. As can be seen from FIG. 4, compared to the aged Comparative Example 72, the force necessary to peel the tape from the test panel increased with the presence of the wax in aged A-C® 540 (4.8 wt. %).

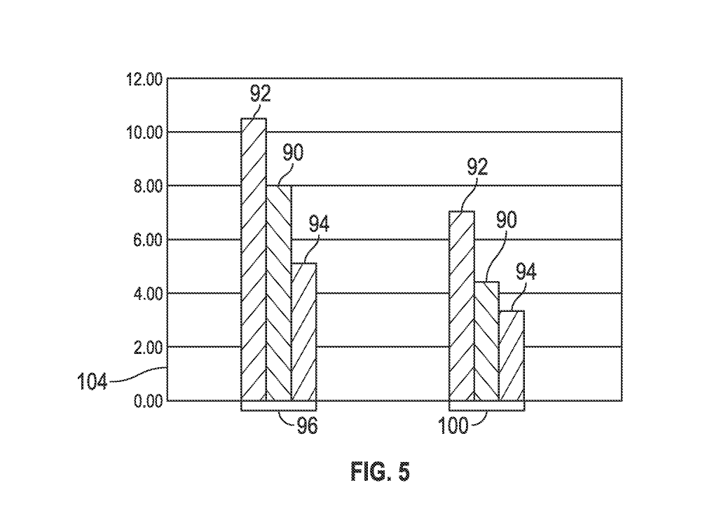

Typically, peel force decreases upon aging. FIG. 5 is a bar chart with the x-axis representing the pressure sensitive adhesives Example 4 90, Example 5 92, and the Comparative Example 94 on aged PVC-2 sheet 96 and aged PVC-1 sheet 100. The y-axis 104 represents the peel force in N/20 mm. As shown in FIG. 5, the peel force of pressure-sensitive adhesive Example 5, that is, with 7 wt. % A-C® 540, on the aged PVC-2 sheet and the aged PVC-1 sheet is considerably greater than the peel force of pressure-sensitive adhesive Example 4, that is, with 4.8 wt. % A-C® 540, on the aged PVC-2 sheet and the aged PVC-1 sheet.

Accordingly, various embodiments of pressure-sensitive adhesives that resist and/or minimize migration of plasticizers from PVC substrates, pressure-sensitive adhesive articles with such pressure-sensitive adhesives and methods for fabricating the pressure-sensitive adhesives have been provided. The pressure-sensitive adhesives are solvent-based and contain a wax that suppresses the migration of plasticizers such as dioctyl phthalate (DOP) or other polymer plasticizers that migrate from the PVC substrates and compromise the adhesive properties of the pressure-sensitive adhesives. The wax is chosen from ethylene-acrylic acid copolymers, ethylene-vinyl acetate copolymers and mixtures thereof

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A pressure-sensitive adhesive comprising:
a wax chosen from an ethylene-acrylic acid copolymer, an ethylene-vinyl acetate copolymer, and mixtures thereof;
natural rubber;
synthetic rubber;
a tackifier; and
a solvent.

2. The pressure-sensitive adhesive of claim 1, wherein the wax is the ethylene-acrylic acid copolymer having an acid number in a range of from about 10 to about 200 mg KOH/g.

3. The pressure-sensitive adhesive of claim 1, wherein the wax is the ethylene-vinyl acetate copolymer having a VA % from about 5 to about 30%.

4. The pressure-sensitive adhesive of claim 1, wherein the wax is present in an amount of from about 1 to about 20 wt. % based on a total weight of the pressure-sensitive adhesive.

5. The pressure-sensitive adhesive of claim 4, wherein the wax is present in an amount of from about 4 to about 12 wt. % based on the total weight of the pressure-sensitive adhesive.

6. (canceled)

7. (canceled)

8. (canceled)

9. The pressure-sensitive adhesive of claim 1, wherein the tackifier has a number average molecular weight (Mn) in a range of about 500 to about 1500.

10. (canceled)

11. (canceled)

12. The pressure-sensitive adhesive of claim 1, wherein the solvent is toluene.

13. (canceled)

14. (canceled)

15. A pressure-sensitive adhesive article comprising:
a PVC substrate; and
a pressure-sensitive adhesive overlying the PVC substrate, the pressure-sensitive adhesive comprising:
a wax chosen from an ethylene-acrylic acid copolymer, an ethylene-vinyl acetate copolymer, and mixtures thereof;
natural rubber;
synthetic rubber; and
a tackifier.

16. (canceled)

17. (canceled)

18. The pressure-sensitive adhesive article of claim 15, wherein the pressure-sensitive adhesive has a thickness in a range of from about 2 to about 150 microns.

19. A method for fabricating a pressure-sensitive adhesive, the method comprising the steps of:
mixing a wax chosen from an ethylene-acrylic acid copolymer, an ethylene-vinyl acetate, and a mixture thereof with natural rubber until particles of the wax are uniformly distributed throughout the natural rubber to form a wax/rubber combination; and dissolving the wax/rubber combination, synthetic rubber, and a tackifier in a solvent.
